(19) United States
(12) Patent Application Publication
(10) Pub. No.: US 2005/0114490 A1
(43) Pub. Date: May 26, 2005

(54) Distributed virtual network access system and method

(75) Inventors: Jens-Peter Redlich, Plainsboro, NJ (US); Wolf Mueller, Berlin (DE)

Correspondence Address: NEC Laboratories America, Inc., 4 Independence Way, Princeton, NJ, 08540, US

(73) Assignee: NEC Laboratories America, Inc., Princeton, NJ (US)

(21) Appl. No.: 10/806,744

(22) Filed: Mar. 23, 2004

Related U.S. Application Data
(60) Provisional application No. 60/523,728, filed on Nov. 20, 2003.

(51) Int. Cl. G06F 15/173

(52) U.S. Cl. 709/223

(57) ABSTRACT

A system and method is disclosed for enabling users to connect to a home network from a remote network using what the inventors refer to as a distributed virtual switch. An access component providing connectivity for user devices is deployed in a remote network and automatically associates packets from a user device with a switch server deployed in the user's home network. The access component dynamically establishes a communication channel with the switch server and forwards packets from the user device to the switch server, which releases the packets in the home network.

This application claims priority to U.S. Provisional Patent Application Ser. No. 60/523,728, entitled “DISTRIBUTED VIRTUAL NETWORK ACCESS SWITCH”, filed on Nov. 20, 2003, the contents of which are hereby incorporated by reference herein.

### BACKGROUND OF THE INVENTION

The present invention is related to access mechanisms for packet-based communication networks.

In a communication network, access to the network is typically provided by means of a local access device, such as a switch or an access point. For example, a packet-based network 101 is depicted in FIG. 1, such as an Internet Protocol (IP) network (e.g., the Internet or corporate intranet) or ATM or Frame Relay network. In FIG. 1, a user device 150 connects to the access device 110, e.g., through some form of layer-2 wired or wireless connectivity 155. The access device 110 can be a switch, router, Ethernet hub, (wireless) access point that receives data packets (e.g. Ethernet frames) from the user device 150 and forwards them into the local network 115 to which the access device 110 is attached. The point of attachment to the network is important for both the user and for the owner/operator of the local network: the point of attachment governs the mechanisms used for local access control, what higher-layer protocols the user may use (e.g., IPv4, IPv6, X.25, DEC DNA, Appletalk, IPX, or PPPoE), and what mechanisms are utilized to obtain a locally correct network configuration, such as the Dynamic Host Configuration Protocol (DHCP). See R. Droms, “Dynamic Host Configuration Protocol,” Internet Engineering Task Force (IETF) Network Working Group, Request for Comments 2131 (March 1997).

Where a user roams to a different physical location and a different point of physical attachment, the user can utilize higher-layer mechanisms—such as virtual private network (VPN) services—to create a virtual connection to a home network. There are also access mechanisms that permit a user to connect to a different point of attachment and continue to operate with the same IP network address or configuration. See, C. Perkins, ed., “IP Mobility Support,” Internet Engineering Task Force (IETF) Network Working Group, Request for Comments 2002, October 1996; U.S. Pat. No. 6,591,306, entitled, “IP NETWORK ACCESS FOR PORTABLE DEVICES,” issued on Jul. 8, 2003, the contents of which are incorporated by reference herein.

Nevertheless, if the user is at a remote place, the user will still need to obtain access to the remote network in order to exchange any traffic with it—before any higher-layer mechanisms, such as a VPN, can be utilized. This necessitates not merely obtaining permission from the local access network, but also knowledge of the local mechanisms and procedures for obtaining permission. For example, if the remote access device uses a media access control (MAC) address-based access control mechanism, the users have to use that very same mechanism. If the remote network does not utilize DHCP, the users may need to manually configure their IP address as well as the addresses for a next-hop router/gateway, or a domain name server (DNS), to name just a few. Moreover, the user interface presented by the remote network [JPR1] may be in a language completely unfamiliar to the user. If two users use the same access device, then both are connected to the same network, i.e. the network to which the access device is attached, and they both will need corresponding permission and be acquainted with the access mechanisms at their current (remote) location. In addition to any access control mechanisms, the owner/operator of the remote network may have to provide each user with another valuable resource: a global IP address. In sum, the user needs to become a full member of the network at the point of physical attachment in order to be able to use any communication services. Only after becoming a member of the remote network is the user able to employ mechanisms, such as VPN, to virtually join a home network.

Accordingly, there is a need for an alternative access mechanism that frees a user from local access conventions and that can enable a user to transparently and securely connect back to the user's home network.

### SUMMARY OF INVENTION

The present invention is directed to a network access architecture that enables a user to access a home network from a remote network using what the inventors refer to as a “distributed virtual switch.” In accordance with an aspect of the invention, an access component providing wired or wireless connectivity for user devices is deployed in a remote network. The access component is capable of automatically associating packets (e.g., layer-2 frames) from a user device with what the inventors refer to as a switch server deployed in the user's home network. The access component preferably does not attach the user device to the remote network and does not release the user's packets into the remote network. Rather, it forwards the packets to the switch server, which then releases the packets on behalf of the user device in the home network. Any authentication and encryption policies can be advantageously enforced at the switch server, rather than at the access component. Packets received at the switch server destined for the user device are forwarded by the switch server back to the particular access component with connectivity with the correct user device. The communication channels between the switch servers and the access components can be advantageously dynamically established across a public data network and released when a user disconnects from an access component.

Thus, when the user connects to the access component, which can be deployed almost anywhere including insecure environments, the user will be given the appearance that the user device is directly connected to the home network. Any local access conventions, such as the use of DHCP, DNS, gateway addresses, user authentication procedures, and so forth, will be governed by the user's home network. Thus, for example, if the user's home network is “within” a firewall and contains protected resources, the user will be permitted to access such protected resources using the access component, since the user's traffic is perceived to be within the firewall. Moreover, two users from different home networks who happen to use the same access component will perceive two different points of attachment to the network. Each user will interact with the same access component as if they were interacting directly with their respective home networks.

The present invention advantageously frees the user from local access conventions. The user does not need to be acquainted with local access mechanisms in the remote network. Moreover, the access component in the remote network does not need to be involved in any access policy issues such as authentication or encryption. No secret information (such as WEP keys) or any security relevant functions need be stored at the access component. Also, the remote network operator does not need to allocate resources such as a global network address to the remote user. Moreover, the present invention advantageously does not necessitate any changes in user devices or the manner in which they connect to a network.

These and other advantages of the invention will be apparent to those of ordinary skill in the art by reference to the following detailed description and the accompanying drawings.

### BRIEF DESCRIPTION OF DRAWINGS

FIG. 1 shows an illustrative prior art architecture for network access.

FIG. 2 shows a diagram of a network access architecture, in accordance with an embodiment of the present invention.

FIG. 3 is a simplified version of FIG. 2, showing how the components depicted in FIG. 2 combine to form a distributed virtual switch.

FIG. 4 is a flowchart of processing performed by an access component, in accordance with an embodiment of the present invention.

FIG. 5 is a flowchart of processing performed by a switch server, in accordance with an embodiment of the present invention.

FIG. 6 shows a diagram illustrating the network access architecture shown in FIG. 2 from the viewpoint of more than one user.

### DETAILED DESCRIPTION

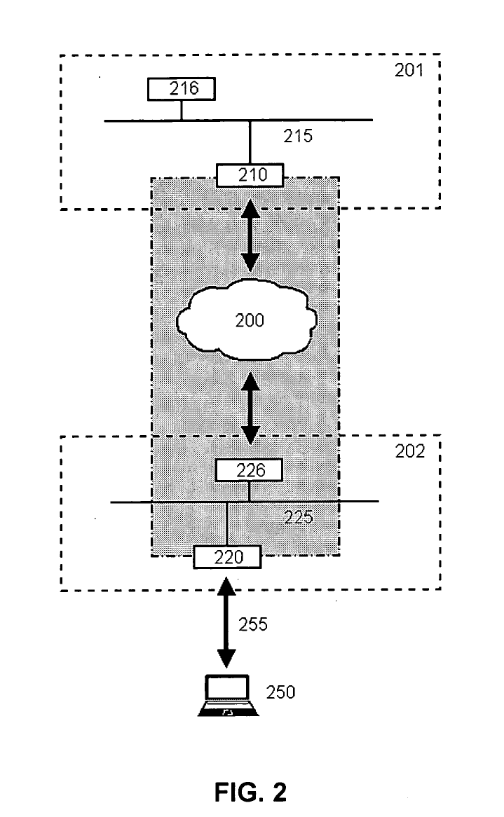

FIG. 2 is a diagram illustrating an embodiment of the present invention. A user device 250 is depicted in FIG. 2 as attempting to access its “home network” 201 from a “remote network” 202. The invention shall be described herein, for illustration purposes only, with particular reference to layer-2 architectures based on Ethernet-related standards and to Internet Protocol (IP) based networks. Nevertheless, it will be appreciated and understood by those of ordinary skill in the art that the present invention is readily extendable to other network architectures. Note that “packets” are usually referred to as “frames” when referring to Ethernet-related standards (e.g., “Ethernet frames” for Ethernet-based networks or “802.11 frames” for WiFi networks), although herein they shall be referred to interchangeably as “packets” or “frames.”

It should be noted that the term “home network” herein refers to any network which can provide access for the user device 250 and which is associated in some manner with the user. The home network typically provides the “normal” working environment for the user, i.e. the user is familiar with the access control mechanisms at the home network and also with the services available at the home network. The user, for example, knows whether the home network provides DHCP or DNS services. The user can have a recognized account on the home network, allocated storage for data files, access to e-mail, ftp, Web, shared files, shared printers, and other personalized services. Most of these services are not available outside the user's home network, or only in a reduced form. The user will therefore desire to be connected to his home network 201, rather than just to an arbitrary network. In addition, the home network is willing to provide and has allocated resources to the user, such as a global IP address or access to the local services.

The term “remote network” herein refers to the network at the user's actual location. In contrast to the prior art, the user advantageously does not need to be familiar with the access control and other policies of the remote network. Also, the user does not need to rely on services such as DHCP and DNS at the remote network, which may not be available there. The user does not even need to speak the same language used in the remote network. The remote network can advantageously be owned and operated by an entity foreign to the user and even the operator of the home network. The remote network operator need not allocate resources such as an IP address to the user.

The user device 250 depicted in FIG. 2 is advantageously any device that can connect to an access network. For example, and without limitation, the user device 250 can be a personal computer, a notebook or tablet computer, a laptop, a personal digital assistant (PDA), a handheld mobile device or appliance, etc. The device 250 has a conventional network interface that enables some form of layer-2 connectivity with access devices. The “user” shall connote herein, both the communication device 250 as well as the person who is using the device 250.

As depicted in FIG. 2, the system for providing users with network access comprises two components: what the inventors refer to as an “access component” 220 and a “switch server” 210. The access component 220 is part of a remote network 202, while the switch server 210 is deployed at a user's home network 201. A user device 250 attaches to the network at the most physically convenient access component 220; it is preferable that the user device 250 does not attach directly to a switch server 210.

ACCESS COMPONENT. The “access component” 220 shown in FIG. 2 differs from a typical prior art access device in many respects. In accordance with an embodiment of an aspect of the invention, the access component 220 is designed to exchange data with user device 250 and communicate over an IP network with switch servers. Access component 220 is, on one side, directly connected to the user. It receives data frames from the user and can send data frames to the user. This transmission can be wireless or wireline, encrypted or unencrypted. It should be noted that the access component 220 itself preferably does not perform the encryption; rather, encryption should be performed, if at all, by the switch server 210, which is described in greater detail below. Access component 220 simply passes the data frame “as is” to the switch server 210. Access component 220 is, on the other side, connected to the remote access network 202 which facilitates access, typically through a router 226, to an IP network 200, such as the Internet or a corporate intranet, for communication with switch server 210.

Access component 220 preferably does not release data from the user directly into the remote network 202. It preferably does not act as a bridge between the user and the remote network 202. The access network 202 will usually not be the user's home network, but rather a remote network. Therefore, the IP addresses used at access router 226 and the services provided by remote network 202, including authentication, will not be the services that the user is used to from his home network 201.

SWITCH SERVER. The switch server 210, in accordance with an embodiment of an aspect of the invention, is a component that is installed as part of the user's home network 201. It acts like a switch in the sense that it receives layer-2 data frames from the user on one side, to be forwarded on the other side to the network 201—and it receives layer-2 data frames from the network 201 on one side, to be forwarded to the user on the other side. The difference with a regular switch is that the switch server 210 has no direct link to the user device 250; rather, it communicates over an IP network 200 with the access component 220 to facilitate the communication with the user. Switch server 210, however, does not need to have a permanent (physical or logical) link to access component 220. Specifically, the switch server 210 preferably communicates with the access component 220 over a dedicated connection that can be dynamically established by the access component 220 when user 250 connected to it. This connection, and hence the link between the switch server 210 and the access component 220, need not be pre-configured. It advantageously can be dynamically created, between arbitrary (not previously known) pairs of access components and switch servers. A new connection can be established when an arbitrary user connects to the access component 220, and can be made to disappear when the user disconnects from the access component 220.

A user takes advantage of this network access architecture by associating with at least one switch server. Each user has a home network and at least one switch server deployed in each home network. The switch server 210 can be made responsible for typical access policy enforcement, such as authenticating the user, determining the user's access permissions, enforcing the determined access permissions, performing accounting, and encryption/decryption of user traffic.

The functions of the switch server 210 and the access component 220 can be readily implemented in hardware, software, or an advantageous combination of the two.

The access component 220 and the switch server 210 are interconnected by communication channel across a network 200. The network 200 can be any network that is capable of delivering packets from a source to the intended destination. In its simplest form, network 200 can be just a layer-2 communication link between the switch server 210 and the access component 220, e.g., such as an Ethernet cable or an Ethernet local area network (LAN). The network 200 can also include a wide area network, a public data network, such as the Internet, or a corporate intranet or VPN. In FIG. 2, the network 200 is illustratively depicted as a public data network which is accessed through a router 226 in the remote network 202.

There need be no a priori association between access components and switch servers. They can be advantageously deployed independently from each other across large areas, potentially globally. Although not depicted in FIG. 2, it is contemplated that there can be multiple switch servers, at least one deployed in each home network. It is also envisioned that there are multiple access components deployed in numerous advantageous remote networks. Note that for increased reliability or to handle high loads, a home network may have more than one switch server. From the user's point of view, these servers can be all equivalent. When a request arrives from an access device, one of these switch servers will be selected, and, for the duration of the session, assume the role of ‘the’ switch server associated with the user.

When a user device 250 attaches to an access component 220, the access component 220 automatically determines the switch server 210 that is associated with that particular user, as described in further detail below. Once the access component 220 has determined the switch server 210 that is associated with the given user, it establishes a connection between the access component 220 and the switch server 210. If more than one user is simultaneously connected to one access component 220, then the access component 220 can potentially have multiple, simultaneous connections to potentially different switch servers. If no user is connected to the access component 220, then no association need exists between the access component 220 and any switch server. The associations between access components and switch servers are created (and terminated) dynamically, depending on the specific users who attach to the access devices. Without active users, access components and switch servers need not be related to each other.

Every data packet that the access component 220 receives from the user, even if it is encrypted, is forwarded, unchanged, through the communication channel with the switch server 210 that is associated with that user. The switch server 210 will receive the layer-2 packet (frame), decrypt it (if it was encrypted), and perform access control functions, including user authentication, determination of access rights and enforcement of access permission and other policies. Finally, provided adequate permission, the layer-2 packet is released into the network 201 to which the switch server 210 is attached to, i.e. into the user's home network 201. In the prior art, an access device would release the layer-2 packets that it received from the user into the network that it was itself connected to. With the present architecture, the layer-2 frame is instead released into the network to which the switch server is connected.

The network access architecture depicted in FIG. 2 serves to extend access to the user's home network 201 to the remote network 202 in a manner that allows the user 250 to take full advantage of the home network 201, including access control and services such as DHCP and DNS. The user's traffic can be forwarded to nodes in the home network 201 such as router 216, which can facilitate communication between different subnets and, in particular, between local nodes and nodes on the larger Internet or corporate intranet that are not local to the home network 201. The home router 216 sees the same IP address for the user 250 regardless of how the user 250 is connected to the home network 201. This is accomplished without requiring resources, such as a global IP address or services such as access control, DHCP or DNS from the remote network.

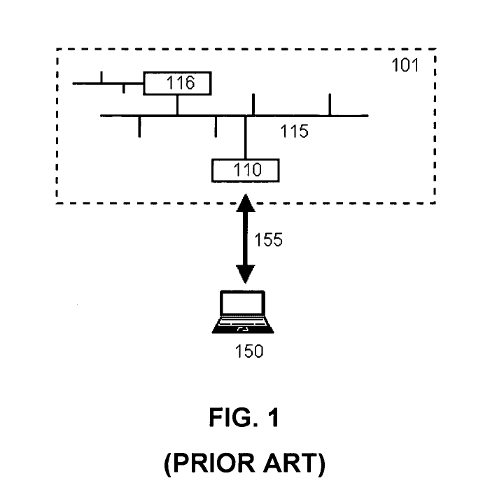

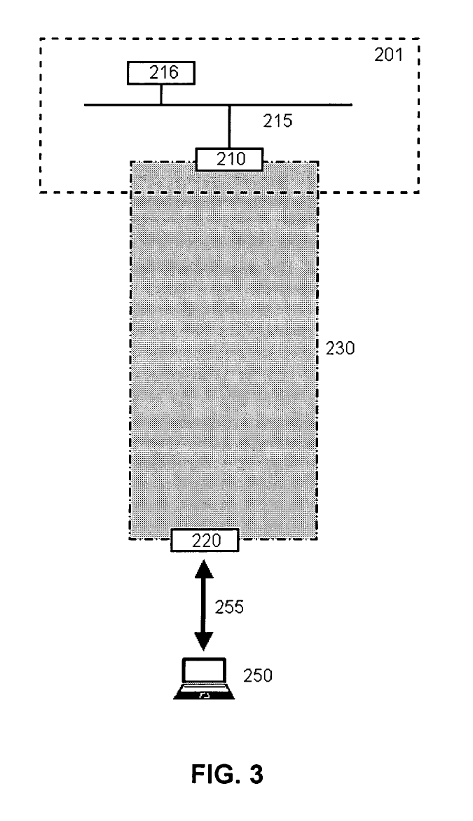

In effect and from the point of view of an individual user, access component 220 and switch server 210 work together to operate like a prior art access switch/device for that given user. FIG. 3 illustrates this notion. FIG. 3 is an over-simplified version of FIG. 2. In a sense, the prior art access device 110 depicted in FIG. 1 has been split into two parts: a first part 220, which directly connects to the user, and a second part 210, which connects directly to the user's home network 201. These two parts, the access component and the switch server, are now separate devices, which are interconnected by network 200. The devices create, in a sense, a virtual distributed device: a virtual and distributed switch 230 that replaces the functionality of the prior art device 110 in FIG. 1. The virtual distributed switch 230 connects on one side directly to the user 250 and on the other side directly to the home network 201. The virtual distributed switch 230 exchanges data packets (layer-2 MAC frames) between the user 250 and the home network 201, possibly under consideration of access rules and other policies. Any functions and processing performed by the prior art switch 110 can be taken over by the virtual distributed switch 230, such as encryption/decryption of data packets (very common, for instance, in wireless access points, using encryption techniques such as WEP or WAPI), user authentication, determination of access permissions for the authenticated user, enforcement of the determined permissions, accounting, traffic classification and shaping. The virtual distributed switch 230 is, of course, not a single physical device. Rather, it is a number of components, the access component 220, the switch server 210 and the network components that connect the two, which work together to create, for a particular user 250, the equivalent to a physical switch. The “switch” 230 is also temporary and virtual. It exists only through the cooperation of the access component 220 and the switch server 210, and it ceases to exist as soon as the user 250 disconnects from the local access device. If multiple users attach to one access component 220, multiple “distributed virtual switches” are created, which may involve different switch servers, depending on where the specific users have their home networks. Every user has his own “virtual distributed switch”, which serves just this one user, does not mix traffic with other users, and ceases to exist if that user is no longer connected to it.

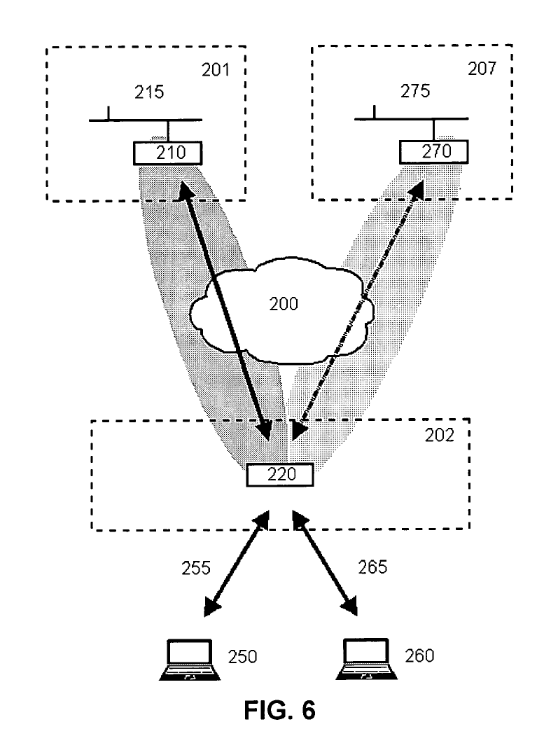

FIG. 6 illustrates what happens when more than one user, e.g. user U1 (device 250) and user U2 (device 260), access the same access component 220. The access component 220 associates every received packet with a user, i.e. in this example either with a user U1 or with U2. Note that although only two users are depicted in FIG. 6, the discussion similarly applies to any number of multiple users. Once the determination has been made of which user a received packet is associated with, the access component 220 forwards the packet to the switch server that corresponds to the determined user, i.e. in this example, data packets received form user U1 would be forwarded to switch server S(U1) which is depicted as 210, and data packets from user U2 would be forwarded to switch server S(U2) depicted as 270 in FIG. 6. Hence, the situation presents itself to user U1 at device 250 such, that a virtual switch connects user U1 to his home network H(U1) 201 such, that the virtual switch (as perceived by user U1) extends from the access component 220 to the home network H(U1) 201. Similarly, U2 perceives a virtual switch, which extents from the same access component 220, but now to user U2's home network H(U2) 207. In essence, the architecture creates different virtual switches for every user. Access component 220 keeps the traffic from both users separate and connects each user to a different virtual distributed switch. Both virtual switches are strictly separate, i.e. the traffic of both users never mixes. Every user is only aware of, and has only access to, their own virtual switch. Even though users U1 and U2 are directly attached to the same access component 220, they both experience different access control mechanisms, network policies, services (DNS/DHCP), EP addresses, and data encryption policies, as those are specific to each virtual distributed switch, and implemented and enforced by the respective switch server in accordance to the policies of the respective home network.

Since the communication between the access component and the corresponding switch servers is realized through a general network, it is possible to establish the association between access device and switch server dynamically, depending on the specific user who is accessing the access device. If no user is connected to an access component 220, no virtual switch exists. In general, if the number of users connected to the access device component is n, then the number of virtual switches created by the access component and the corresponding switch servers S is also n.

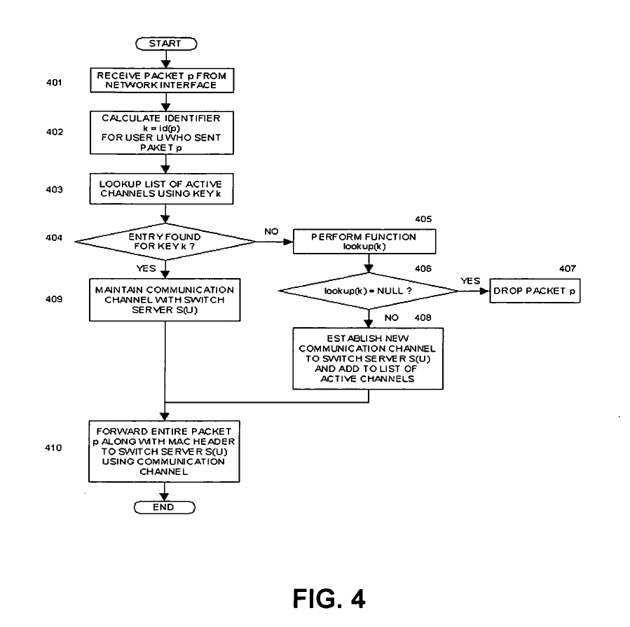

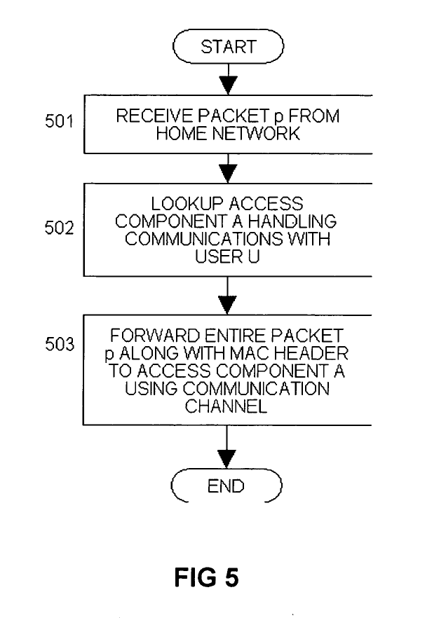

FIGS. 4 and 5 further illustrate the operation of the access component 220 and the switch server 210 depicted in FIG. 2.

FIG. 4 is a flowchart showing processing performed by an access component, in accordance with an embodiment of the present invention. As discussed above, the access component does not simply forward data packets (e.g., layer-2 MAC frames) from one side to the other. Rather, as depicted in FIG. 4, it performs the elaborate process of:

Step 401: Receiving packet p from its network interface with the user.

Step 402: Associating the received packet p with a user U, by means of the identification function id(p), implementations of which are further described below. The identification function id(p) returns an identifier k that uniquely identifies the user who sent the packet p.

Step 403: Lookup identifier k in a list of active channels in order to identify a switch server S(U) associated with the user U. This can entail checking a table of associations as further described in detail below.

Step 404-405: If no active channel can be found for key k, a network wide lookup function ‘lookup(k,p)’ is performed, as further described in detail below. This function will locate the switch server S(U) for a new user U for which no active channel exists yet.

Step 406-407: If lookup(k,p) returns NULL, no switch server S(U) could be located and it is preferable that the packet p be dropped.

Step 408: If lookup(k,p) is successful in identifying a switch server S(U) for user U, as identified by p and k, then a new channel to that switch server is created and an entry added to the list of active associations.

Step 409: If an active association to switch server S(U) could already be found in step 403, then the association is simply maintained.

Step 410: Forwarding the entire packet p to the switch server S(U) that corresponds to the user U. The entire data packet is preferably transmitted to S(U), including the layer two (MAC) header. If the data packet p was encrypted by the user, then the packet remains unchanged, i.e. the still encrypted data packet is transmitted to S(U). In order to send packet p over an IP network from the access component to switch server S(U), it may be advantageous to encapsulated the packet in an IP or UDP packet using, for example and without limitation, known tunneling mechanisms.

FIG. 5 is a flowchart of processing performed by a switch server in the reverse direction. At step 501, the switch server S(U) receives data packets p for user U from the user's home network H(U)—just like a prior art switch at the user's home network. At step 502, the switch server S(U) determines whether there is an active communication channel with an access component A on behalf of the user U. The switch server may, for example, use the identification function id(p) from FIG. 4, or packet p's source IP address, to determine which user U, and hence which access component A, is associated with the received packet p. Then, at step 503, S(U) forwards the entire data packet p to the corresponding access component A, using the communication channel that exists between S(U) and A. The access component A then forwards the packet p (unchanged) to the user U.

IDENTIFICATION FUNCTION. The access component A receives packets p through its user-side network interface and implements a function id(p), which returns an identifier/key that uniquely identifies the user who sent the packet p. The exact structure of the identifier is not relevant to the present invention, someone of skill in the art can readily define an advantageous string or binary representation. The identification function id(p) can be implemented in many possible ways, for example and without limitation:

(a) id(p) can return the media access control (MAC) source address of packet p. Even if packet p is encrypted, the MAC source address is typically always in the clear. The MAC source address uniquely identifies the network card in the user's communication device. MAC source addresses can be, for example, Ethernet MAC addresses, ATM addresses, telephone addresses, or any other address format that is used on the MAC layer to identify the user's network interface.

(b) If the MAC layer uses an encryption protocol, such as the WEP (Wired Equivalent Privacy) security protocol, then the encryption key number with the MAC address can together define a useful identifier id(p). \WEP performs encryption with one of up to 4 pre-installed encryption keys, where each data packet has an indicator which of the 4 WEP keys was used to encrypt it. This indicator is called the ‘WEP key number’. Id(p) can now be defined as the concatenation of the MAC-source address contained in p, and the number of the WEP key that was used to encrypt the packet p. This definition of id(p) allows the user device to choose between multiple (up to 4) different identities by choosing between the up to 4 available WEP keys.

(c) If the data packet is not encrypted, and if the layer-3 protocol used by the user is IP, then id(p) can simply return the source-IP address contained in data packet p. This approach works only well if the user has a fixed global IP address.

(d) id(p) can also be any hash function with the property that, for any two packets p1 and p2, with p1 originating from user U1 and p2 originating from U2, it is always true that id(p1)≠id(p2). Note, that the implementations described under (a)-(c) above should have this property.

SWITCH SERVER LOOKUP. There are a number of ways of permitting an access component A to identify a switch server once the access component has retrieved an identifier from a packet p. For example and without limitation, the access component A may maintain a table T of active associations with two columns. Column 1 contains a value id(p) that was obtained from a previously received data packet from user U; column 2 contains the address of a switch server S(U) that is attached to that user U's home network. The address of S(U) may be, for instance, a UDP address, comprising the IP address of the switch server S(U) and a UDP port number that is valid on S(U). Someone skilled in the art can easily substitute this addressing scheme with another, equivalent addressing scheme, useful for implementing a communication channel between A and S(U). Table T may also contain information in each entry (row) that is useful for maintaining a dedicated communication channel between the access station A and the switch server S(U)—such as a socket identifier or communication link identifier. Possible communication channel implementations include, but are not limited to: IP tunnels, UDP tunnels, PPP tunnels, switched circuits, switched virtual paths.

When access station A receives a packet p, it can first calculate the value of id(p), and use the result of this computation, k, to identify an entry (row) in table T which has that value in column 1. The rest of that entry would then contain the address of the associated switch server S(U), along with additional useful data to maintain the association. The packet p can now be forwarded, over the identified communication channel, to the identified switch server S(U).

An implementation is advised, but not required, to include a timestamp in each entry of table T that indicates the time when an entry was last used in response to an incoming packet p. This timestamp can be used to remove entries that have not been used for extended time. Timeout and garbage collection, if implemented, ensure that data for connections that do not exist anymore are removed eventually from the access device's memory. On the other hand, no harm is done if an entry is removed too early, as a new packet from user U will automatically create a new entry that is equivalent to the one that was just garbage-collected. However, (re-) establishment of an entry and the associated communication channel between A and S introduces a delay, which is why timeout thresholds preferably should not be chosen too small.

Access station A may receive a packet p for which id(p) computes a value that is not yet in table T. In this case, it is preferable that the access station A perform a lookup operation, for example, as follows:

Let the key k be defined as k=id(p), i.e. k is a unique identifier for the user U who sent the packet p. Access station A may now perform the lookup function lookup(k), which returns either NULL or the address of a switch server S(U) that is attached to the home network of user U. Access station A may buffer the packet p while the function lookup(k) is performed.

If lookup(k) returns a value other than NULL, then a new entry is added to table T, and a communication link to the indicated switch server S(U) is created. Note, that the address returned by lookup(k) may already contain all necessary information, such as source/destination ip-address/udp-port-number, so that the communication link between access device A and said switch server S(U) is already available and does not require further setup. Once the entry has been added to table T. subsequent packets p from the associated user will result in the selection of that entry and the forwarding of the packet to the corresponding switch server S(U).

If lookup(k) returns NULL, it is assumed that no switch server could be identified for the user who sent the packet p. The access station A should preferably now drop the packet p and continue its normal work. To speed up this process for subsequent packets p from the same, unidentifiable user U, it is recommended, but not required from an implementation of access station A, to maintain a negative-list of values k (i.e. values of id(p)), for which lookup(k) has previously returned NULL—to avoid further execution of the lookup function for the same value k. If such a mechanism is implemented, it is further recommended to equip it with a timeout mechanism for every entry, to ensure that a user is not blocked forever, but that the lookup(k) function may be performed again—from time to time—to address the possibility that a previously unidentifiable user U has, in the meantime, obtained a user account with some home network, and would therefore from now on be identifiable.

Many implementations of the lookup function lookup(k) would be apparent to someone skilled in the art. For example and without limitation, two such implementations are the following:

1. Access station A may broadcast the value k to all potential switch servers S. Assuming that every switch server S has knowledge of the users in the (home-) network it is attached to, every switch server that receives such a lookup-broadcast can decide if it is the correct switch server, and if it is, send a reply to A (if S determined that it is not the correct switch server for the broadcasted value of k, it should preferably remain quiet). Alternatively, one skilled in the art would readily imagine modifying this approach to extend to lookup request that are not broadcast to all network nodes, but rather multicast to all switch severs. Furthermore, the nodes involved in forwarding the lookup multicast could maintain a cache with previously positive identified values of k, as well as previously processed values of k for which no positive reply was received from a given multicast sub-tree.

It is also possible to include the entire packet p in the lookup(k) broadcast. This is especially valuable if the packet is encrypted, because the switch server S could prove to the access device A that it is the correct switch server by demonstrating its ability to decrypt the enclosed packet p. Furthermore, this would provide additional security to the switch server S, in case a malicious user U sends a packet p for instance with an incorrect MAC address—which would at first lead to an incorrect switch server S; but the switch server would recognize the fraud immediately, because the packet p would not be correctly encrypted.

2. A globally available DNS service could be used to implement the lookup(k) function. A DNS domain could be reserved, for instance “lookup.org”. Every switch server S operational at any home network H, would register all users U under that domain, similar to computer names that can be registered under a DNS domain. For instance, if a switch server has an account for user U, it could calculate the valued k=id(p) for packets p that this user U would sent out. Then, the switch server would register a DNS name “<k>.lookup.org”, where <k> is the actual value of k. The IP address associated with this DNS name would be the IP address of the switch server S that performed the registration. If an access device has to perform a lookup(k) function, all it has to do is to perform a DNS lookup for the name “<k>.lookup.org”. If this DNS lookup returns an IP address, than this is the address of the corresponding switch server S, and hence the return of lookup(k). If, on the other hand, the DNS lookup does not return any value, then the return value of lookup(k) is considered NULL.

IMPLEMENTATIONS. In this discussion, it will be appreciated that the disclosed network access architecture may be implemented in a number of concrete ways as will be evident to one familiar with this field. In particular, the system and method described herein may be implemented entirely in hardware, software or a combination of both. Specifically, the access component, the switch server, or any other hardware element utilized by the present invention, may include a processor and a memory under control of the processor. The memory may be provided with instructions (software) that are executed by the processor, and enable the processor to cause the access device, the switch server, or other hardware, to perform in certain ways. Likewise, an access component, a switch server, or another element utilized by this invention, could be implemented partly in hardware and software.

The disclosed network access architecture may also be used in conjunction with wireless and wire-line access alike, where “wireless” may mean any short-range or long-range technology that operates in either licensed or unlicensed frequency bands.

Exemplary applications of the disclosed architecture described herein include, but are not limited to the following cases:

(a) IEEE 802.11 Corporate Wireless LAN Access System. This embodiment of the present invention describes a system for wireless access to a corporation's network. It may be used primarily by the corporation's employees in order to get access to corporate resources (email, printer, web services). It may also be used by visitors of that corporation to get access to resources in their respective corporate networks or on the public Internet.

An installation of the envisioned Corporate Wireless LAN Access System utilizes one or more access components (A) and usually one, but possibly more, switch servers (S). An access station (A) is a device (box) with an IEEE 802.11 compliant network interface toward the user and a network interface of some kind toward the corporate IP network. A switch server (S) is a device (box) with one or more network interfaces, such that the access components (A) and the switch server (S) can communicate with each other over the corporate IP network.

The switch server (S) may be installed in a secure location at the corporate premises, such as a machine room. The switch server (S) stores security sensitive information, such as user accounts and corresponding WEP keys. It also performs security related functions, such as authentication and enforcement of access decisions and policies. It is therefore essential to provide physical security for the switch server, to make it harder/impossible for an adversary to get access to the secret information or to alter the security related algorithms by tempering with the physical device.

The access components (A) may be installed throughout the corporate premises, preferably close to potential users. Because access components and switch servers communicate with each other over an IP network, it is not necessary to have a direct wire-link available between access component and switch server. In contrast to the switch server, it is not necessary to physically restrict access to the access components, as the access component does not store any secret information, does never have access to secret information and does also not perform authentication or access control enforcement. Therefore, an adversary can gain no benefit from physical access to the access component. This makes it acceptable to install some of the access components in public areas, outside the corporate main premises, such as libraries, cafeterias, and waiting areas, where their physical security is not guarantied.

Employees (users) can now connect their computers, laptops, PDAs or other communication gear to the access component (A) in exactly the same way as they would connect to a regular 802.11 access point. Specifically, this means that users do not need to make any hardware/software/configuration changes to their devices in order to benefit from the envisioned system.

When a user connects to the access component and sends the first data packets, the access component will automatically, i.e. without any action to be taken by the user, identify that user's switch server S, establish a communication channel to the identified switch server S and forward all 802.11 frames that it receives from that user to the switch server (note: if the user sends encrypted 802.11 frames, the access component sends the still encrypted frame to the switch server—this is a major difference to prior art technology, where the access point would perform the decryption of any encrypted data frames). The switch server receives the frame from the access component and, if it was encrypted, decrypts it. Furthermore, the switch server may perform user authentication, access control and accounting functions, all of which are well known to someone skilled in the art.

The switch server will receive data frames that are destined for the user's communication device—similar to the way a prior-art switch would receive those packets. The switch server would then, optionally, perform policy control and convert the received data packet into an 802.11 frame, optionally perform encryption on this frame and forward it to the corresponding access component over the IP network. The access component forwards the 802.11 frame, unmodified, to the user, who may decrypt it and process it further.

If the user uses DHCP in order to obtain an IP configuration, including an IP address for his communication device, those DHCP requests would be released at the switch server. Consequently, the user would obtain an IP address that belongs to the IP subnet to which the switch server is attached, and not an IP address from the access component's network. Moreover, the access network does not have to provide DHCP service at all.

All employees would always be connected to the IP subnet to which the switch server is connected. The IP subnet to which the access component is connected would have no impact on the user's IP configuration or available services. Moreover, it is possible that the access component is connected to a subnet that is not part of the trusted corporate intranet at all, as long as it allows for communication between the access component and the switch server. Such “untrusted” subnets may be used to connect to locations outside the company's secured office space, such as libraries, waiting areas or cafeterias.

If the user uses DNS in order to resolve host names to IP addresses, such DNS requests would be released at the switch server and not in the access network. The user would therefore have access to DNS entries that are published only within his corporation.

The user will have access to any and all services of his corporate network in exactly the same way as he would have access to those services if he where directly connected to his home network.

For increased security, the switch server may implement a 2^{nd} stage user authentication as follows. A user would first have to pass the 1^{st} stage authentication, which consists basically of the verification that the user has the correct WEP key, i.e. that incoming traffic from the user can be correctly decrypted with the WEP key on file for that user at the switch server. The 2^{nd} stage authentication would restrict the user's access to a few services, such as DHCP, DNS and a local web-server with corporate or directory information. Specifically, the local web-server would contain a web-page with a login-screen that allows the user to enter his user-id and password. The switch server can then use the corporate RADIUS server (or another corporate user authentication service) to verify the user's authenticity and, if successful, grant more access rights to the user. To help the user with the 2^{nd} stage authentication, the switch server may automatically re-direct HTTP-requests for non-local web-pages to the login-page, as long as the 2^{nd} stage authentication has not been completed. The described 2^{nd} stage authentication is an optional addition to the present invention.

(b) Wireless Network Access in a Multi-Tenant Building. We assume a building that is shared by multiple tenants, for instance an office building that hosts multiple corporations, or independent divisions of a corporation. The present embodiment of the invention describes a system for wireless access to the private networks of those tenants in a way that the access components can be shared by all tenants.

Every tenant installs at least one switch server (S) inside their corporate intranet.

Access components (A) are installed throughout the building, in such a way that they provide good radio communication to all places within the building. There is no association between access components and tenants. It is therefore also conceivable that the access components are installed by the building owner.

It is assumed that the corporate intranets of all tenants and the access components are interconnected through some IP network, for instance the public Internet, or a special intranet for the building.

When an employee (user) of one of the tenant companies attaches his communication device to any one of the access components, the mechanisms described in this invention will automatically—i.e. without any assistance or action from the user—create a distributed virtual switch that connects that particular user to his corporation's network (i.e. that user's home network). In fact, the user can obtain access to his corporation's private network from any access component within the entire building, including places within his own corporation, but also from shared areas and from within other corporations of that building. If he is accessing the network from within another corporation, he will have no access to the visited corporation's network. His IP address will come from his home network and not from the visited corporation's network (remote network). His own traffic and the traffic of the visited corporation will never mix.

A separate instance of the distributed virtual switch would be created for another user who may chose to connect to the same access component. Both virtual switches would keep the traffic of both users apart and connect them directly to their, potentially different, home networks. Each user would therefore have the perception that all access components in the building are connecting him directly to his corporation's network (an donly to his corporation's network). An employee from another corporation would say the same, but in regard to his corporation.

Every tenant (corporation) would maintain full and independent control over their access switch, which is the component that implements all network policies, including the security policies. It is therefore possible, with the present invention, that every tenant may employ a different set of policies, which he can define, alter, and enforce independent from any other tenant of the building. All tenants share the same access component installation—i.e. the coverage area of their system is the same for all tenants—the entire building—even tough every tenant is free to operate his system independently from the others, most specifically in respect to security policies.

The embodiment described in this section solves an important problem that prior art technology can not solve: The avoidance of rf interference between independent wireless LAN installations in tightly pact office buildings. For various reasons, corporations want to retain full control of their network infrastructure. Every tenant corporation will therefore want to install its own wireless LAN infrastructure. With prior art technology, this involves he installation of access points that communicate over the 802.11 radio spectrum with their users. Every tenant corporation will have to install a larger number of such access points, which, for all tenants together, may lead to a rather large number of access points being installed within the (small) building. However, if this is done as described, the number of access points in the building may exceed the number of access points that can be installed within a building of the given size without causing interference. Interference will lead to significant performance degradation of the wireless LAN system. The source of this problem is that every prior-art access point is associated with exactly one tenant. This makes it necessary for other tenant corporations, who desire coverage in the same area, to install an access point of their own in the same location. The result is a large number of access points within the same location. Unfortunately, because of the way 802.11 networks are designed, it is not possible to operate large numbers of access points within the same location without causing massive interference between them.

With the present invention it is possible that all tenant corporations share the same access component infrastructure without sacrificing their administrative independence.

Another prior art suggests the following solution to this problem: The building owner installs a wireless LAN system throughout the entire building. Users would then use VPN software to ‘dial-in’ to their corporate networks, using the wireless LAN as their access network. While this prior art technology can alleviate the rf interference problem, it burdens the user with the ‘dial-in’ VPN establishment procedure—which requires installation of appropriate software on the user device. Such software may not be available for certain device types. In addition, the wireless LAN access network would have to provide basic IP configuration services and IP addresses to the users, to enable them to establish VPN connections. In addition, the fact that all users share the same wireless access network creates an additional security risk, as access from one user to another may be possible before the VPN is activated or if the VPN installation has been done incorrectly.

(c) Access to a user's home network from public places. The present invention can also be used to provide users with access to their home network, such as a corporate intranet, from public places, such as hotels, stores, and airports.

The switch server (S) may be installed in the user's home networks, while access components may be installed in various public places where access should be made available.

The user would connect to the access components (A) in exactly the same way as he would connect to a regular 802.11 access point. Actually, the automatically created virtual switch gives the user the impression that he where connected to a network access component of his home network. He would encounter the same authentication procedures, IP addresses and services that he also uses when physically present at this home network. Another user would cause the creation of another virtual switch that is specific to that user, and which would provide that second user with access to his home network, employing all the authentication and other procedures that this 2^{nd} user is used to.

The present invention provides the user with the following advantages that can not normally be found, at least not altogether, at prior art technology:

First, the user does not need to install any new hardware or software, nor does he have to change his configuration settings in order to take advantage of the present invention. This does not only free the user from making those changes and potentially reversing them when he returns to his home network. It also makes the present invention available to communication devices for which the additional hardware or software required by prior art technology (e.g. VPN) is not available.

Second, the user is instantaneously presented with his virtual switch, which serves exclusively him, and which connects him directly and exclusively with his home network. The user does not have to learn local authentication procedures, as those procedures will be performed by the switch server (S) at his home network. Hence, every user will be presented with his individual authentication procedures and security policies. Naturally, those procedures would be based on the language of that individual user (because those procedures would be performed by his home network).

Third, because every user is controlled by his individual home switch server, the owner or operator the public space where the access components are installed does not need to own or operate a switch server. Many prior art technologies require a device that governs network access to be installed at the public space. Those devices would belong to the owner/operator of the public space and would have to be maintained by him, unless he outsources these duties to another organization, such as a network operator.

Fourth, the user would obtain his IP address from his home network. This not only allows the user to operate within his known IP address space, but it also frees the owner/operator of the public space, where the access components are installed, to provide an IP address to the user.

(d) Corporate Wireless LAN access system for corporations with facilities in different locations. This application is similar to the Corporate Wireless LAN system described before. It assumes that a corporation has facilities in many different locations, which may or may not be independent administrative domains. Furthermore it is assumed that at least some employees have to travel between these facilities and that those employees wish to access their home network from their visited (remote) locations.

Every administratively independent domain, i.e. a domain which has a separate security policy, authentication procedures or IP address space, should install its own switch server (S) inside its corporate network.

Locations which do not qualify for an independent administrative domain do only install access components, but no switch servers.

When a user travels to any of the facilities, he finds an access component to which he can connect. A virtual switch will be automatically created, which serves him individually, and which connects him to his home network.

As a result, the user has instant access to his home network from all facilities that are equipped with the described technology. The user will always have the perception that he is directly connected to his home network—and not to the local access network. He will also encounter his individual authentication procedures and security policies—which he knows from his home network, and which are implemented and performed by his home network.

The network infrastructure of a company with that many facilities may actually be comprised of many different, and potentially administratively independent sub-networks. However, with the present invention, a user would have the perception that all these facilities would be covered by the same network—his home network—which provides him with access to his home network resources from any of these facilities.

1. A method of operating an access device comprising:
receiving a packet at an access device deployed in a first network;
automatically identifying a switch server in a second network, where the switch server is associated with an identifier obtained from the packet;
forwarding the packet to the switch server in the second network so that the switch server can release the packet in the second network without releasing the packet in the first network.

2. The method of claim 1 wherein the packet is a layer two frame.

3. The method of claim 2 wherein the packet is received from a user device with layer two connectivity with the access device.

4. The method of claim 3 where the first network is a remote network and the second network is a home network for a user of the user device.

5. The method of claim 3 wherein the identifier comprises a media access control address associated with the user device.

6. The method of claim 3 wherein the identifier comprises a media access control address associated with the user device and a cryptographic key identifier.

7. The method of claim 3 wherein the identifier comprises a network layer address.

8. The method of claim 1 wherein the packet is forwarded using a communication channel established across a public data network between the access device in the first network and the switch server in the second network.

9. The method of claim 8 where communication channels are established between the access device in the first network and a plurality of switch servers in different networks dynamically based on which users have established connectivity with the access device.

10. The method of claim 8 where communication channels are dynamically established between access devices and switch servers which have no prior knowledge of each other.

11. The method of claim 4 in which the user device connects in a same manner as it connects to the home network.

12. The method of claim 4 where the remote network does not need to allocate an IP address for the user device.

13. The method of claim 4 where the remote network is not involved in performing user authentication and access control.

14. The method of claim 1 wherein the switch server is identified by performing a lookup request using the identifier obtained from the packet.

15. A system for remote access to a home network from a remote network, comprising:
one or more switch servers, each switch server deployed in a home network associated with one or more users; and
an access device for deployment in a remote network and providing connectivity for user devices, such that packets arriving at the access device from a user are forwarded to the switch server in the home network associated with the user and released into the home network without releasing the packets into the remote network.

16. The system of claim 15 wherein the packets are layer two frames.

17. The system of claim 16 wherein the access device establishes communication channels to switch servers dynamically based on which users have established connectivity with the access device.

18. The system of claim 15 wherein the access device selects which switch server to forward a packet based on an identifier obtained from the packet, where the identifier is associated with one of the switch servers.

19. The system of claim 15 wherein multiple user devices having connectivity to the access device may be connected to different home networks and where the user devices connect in a same manner as they connect to their respective home networks.

20. An access device comprising:
a network interface for establishing connectivity with one or more user devices;
a packet analysis module capable of obtaining an identifier from a packet received from the network interface and identifying a switch server in a second network associated with the identifier;
means for dynamically establishing a communication channel with one or more switch servers so that a packet associated with a switch server can be forwarded to the switch server and released in the second network without releasing the packet in a local network.

21. The access device of claim 20 where the packets are layer two frames.

22. The access device of claim 20 in which the user device connects in a same manner as it connects to the second network.

23. The access device of claim 20 where the network interface provides wired connectivity with the user devices.

24. The access device of claim 20 where the network interface provides wireless connectivity with the user devices.

25. The access device of claim 20 where traffic from the user devices are not bridged with any nodes in the local network.

26. A switch server comprising:
a network interface for connecting to a home network of a user; and
an access module capable of maintaining communication channels with one or more access devices and receiving packets from the access device on behalf of a user device and releasing the packets using the network interface into the home network of the user.

27. The switch server of claim 26 where the packets are layer two frames.

28. The switch server of claim 26 wherein the switch server is responsible for local access policy enforcement.

29. The switch server of claim 26 further comprising a decryption module for decrypting packets from the access device.

30. The switch server of claim 26 further comprising a lookup module that responds to lookup requests from access devices.

31. A device-readable medium comprising program instructions for causing an access device deployed in a first network to perform the steps of:
receiving a packet;
identifying a switch server in a second network, where the switch server is associated with an identifier obtained from the packet;
forwarding the packet to the switch server in the second network so that the switch server can release the packet in the second network without releasing the packet in the first network.

32. The device-readable medium of claim 31 wherein the packet is a layer two frame.

33. The device-readable medium of claim 31 wherein the packet is received from a user device with layer two connectivity with the access device.

34. The device-readable medium of claim 33 where the first network is a remote network and the second network is a home network for a user of the user device.

35. The device-readable medium of claim 33 wherein the identifier comprises a media access control address associated with the user device.

36. The device-readable medium of claim 33 wherein the identifier comprises a cryptographic key.

37. The device-readable medium of claim 33 wherein the identifier comprises a network layer address.

38. The device-readable medium of claim 31 wherein the packet is forwarded using a communication channel established across a public data network between the access device in the first network and the switch server in the second network.

39. The device-readable medium of claim 38 where communication channels are established between the access device in the first network and a plurality of switch servers in different networks dynamically based on which users have established connectivity with the access device.

40. The device-readable medium of claim 31 wherein the switch server is identified by performing a lookup request using the identifier obtained from the patent.
